(19) United States
(12) Patent Application Publication
(10) Pub. No.: US 2026/0135833 A1
(43) Pub. Date: May 14, 2026

(54) METHOD AND SYSTEM TO PROVIDE ANNOTATION-BASED DOMAIN MAPPING

(71) Applicant: JPMorgan Chase Bank, N.A., New York, NY (US)

(72) Inventors: Rohit RAJ, Bangalore (IN); Amit RASTOGI, Bengaluru (IN)

(73) Assignee: JPMorgan Chase Bank, N.A., New York, NY (US)

(21) Appl. No.: 19/008,208

(22) Filed: Jan. 2, 2025

(30) Foreign Application Priority Data
Nov. 14, 2024 (IN) 202411088242

(51) Int. Cl. H04L 61/4511; G06F 40/205

(52) U.S. Cl. CPC H04L 61/4511; G06F 40/205

(57) ABSTRACT

A method and system to provide annotation-based domain mapping are disclosed. The method includes receiving a plurality of source domain objects and destination domain objects from a user. Further, the method includes storing the plurality of source domain objects and destination domain objects. Further, the method includes analyzing the destination domain objects to extract predefined annotations. Further, the method includes parsing the predefined annotations to extract mapping details and conditional details. Further, the method includes traversing a metadata graph generated based on the predefined annotations to identify a matching path in a source domain that correlates with a class path present in the metadata graph, and evaluating at least one condition associated with the matching path using at least one source attribute value. Further, the method includes mapping the source attribute value to at least one destination attribute value, upon satisfying the at least one condition.

### CROSS-REFERENCE TO RELATED APPLICATIONS

This application claims priority benefit from Indian Application No. 202411088242, filed on Nov. 14, 2024 in the India Patent Office, which is hereby incorporated by reference in its entirety.

### FIELD OF THE DISCLOSURE

This technology generally relates to domain mapping, and more particularly relates to methods and systems to provide annotation-based domain mapping.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In recent years, the demand for digital ecosystems to process and share large-scale data from one service to another has increased exponentially across various fields. In modern digital ecosystems, large-scale data is distributed across diverse domains, systems, and applications, each with its own data models, schemas, and formats. Interoperability and data sharing between these domains are essential for enabling seamless communication, collaboration, and data-driven decision-making. One of the existing techniques used for data sharing and data integration between services is domain mapping.

Existing solutions for data integration and data sharing typically rely on manual domain mappings or custom integration code to bridge the gap between different data sources. These approaches are labor-intensive and error-prone, and lack flexibility, making it difficult to adapt to changes in data schemas or requirements. Moreover, maintaining mappings between evolving data models and domains poses additional complexities and overhead.

Existing domain mapping utilities often require developers to write custom code for each mapping. This process is time-consuming and error-prone, and lacks adaptability for diverse mapping scenarios. Existing domain mapping utilities often lack conditional mapping capabilities, restricting their effectiveness in complex mapping requirements. Additionally, the existing domain mapping utilities require higher maintenance costs due to error generations caused due to manual code development.

Hence, in view of these and other existing limitations, there arises an imperative need to provide an efficient solution to overcome the above-mentioned limitations and to provide a method and system that provide annotation-based domain mapping to solve the issues faced during the mapping of data entities between different domains.

### SUMMARY

The present disclosure, through one or more of its various aspects, embodiments, and/or specific features or sub-components, provides, inter alia, various systems, servers, devices, methods, media, programs, and platforms to provide annotation-based domain mapping.

According to an aspect of the present disclosure, a method to provide annotation-based domain mapping is disclosed. The method is implemented by at least one processor. The method includes receiving, by the at least one processor, a plurality of source domain objects and a plurality of destination domain objects from a user. Next, the method includes storing, by the at least one processor, the plurality of source domain objects and the plurality of destination domain objects into a repository. Next, the method includes analyzing, by the at least one processor, the plurality of destination domain objects to extract predefined annotations. Next, the method includes parsing, by the at least one processor, the predefined annotations to extract mapping details and conditional details. Next, the method includes traversing, by the at least one processor, a metadata graph generated based on the predefined annotations to identify a matching path in a source domain that correlates with a class path present in the metadata graph; and evaluating at least one condition associated with the matching path using at least one source attribute value. Next, the method includes mapping, by the at least one processor, the at least one source attribute value to at least one destination attribute value, upon satisfying the at least one condition.

In accordance with an exemplary embodiment, the method may include traversing, by the at least one processor, the metadata graph to identify an alternative matching path that correlates with the class path for mapping the at least one source attribute value to the at least one destination attribute value, upon failure to meet the at least one condition.

In accordance with an exemplary embodiment, the predefined annotations may include the at least one destination attribute value.

In accordance with an exemplary embodiment, the at least one source attribute value may be retrieved from the plurality of source domain objects.

In accordance with an exemplary embodiment, the method may include determining, by the at least one processor, an eligibility of the at least one destination attribute value represented through the matching path.

In accordance with an exemplary embodiment, the metadata graph may have a binary tree data structure.

In accordance with an exemplary embodiment, the traversing of the metadata graph may be performed recursively to enhance path identification.

According to another aspect of the present disclosure, a computing device configured to implement an execution of a method to provide annotation-based domain mapping is disclosed. The computing device includes a processor; a memory; and a communication interface coupled to each of the processor and the memory. The processor may be configured to receive a plurality of source domain objects and a plurality of destination domain objects from a user. Next, the processor may be configured to store the plurality of source domain objects and the plurality of destination domain objects in a repository. Next, the processor may be configured to analyze the plurality of destination domain objects to extract predefined annotations. Next, the processor may be configured to parse the predefined annotations to extract mapping details and conditional details. Next, the processor may be configured to traverse a metadata graph generated based on the predefined annotations to identify a matching path in a source domain that correlates with a class path present in the metadata graph, and to evaluate at least one condition associated with the matching path using at least one source attribute value. Next, the processor may be configured to map the at least one source attribute value to at least one destination attribute value, upon satisfying the at least one condition.

In accordance with an exemplary embodiment, the processor may be further configured to traverse the metadata graph to identify an alternative matching path that correlates with the class path for mapping the at least one source attribute value to the at least one destination attribute value, upon failure to meet the at least one condition.

In accordance with an exemplary embodiment, the predefined annotations may include the at least one destination attribute value.

In accordance with an exemplary embodiment, the at least one source attribute value may be retrieved from the plurality of source domain objects.

In accordance with an exemplary embodiment, the processor may be further configured to determine an eligibility of the at least one destination attribute value represented through the matching path.

In accordance with an exemplary embodiment, the metadata graph may have a binary tree data structure.

In accordance with an exemplary embodiment, the processor may be further configured to traverse the metadata graph recursively to enhance path identification.

According to yet another aspect of the present disclosure, a non-transitory computer-readable storage medium storing instructions to provide annotation-based domain mapping is disclosed. The instructions include executable code which, when executed by a processor, may cause the processor to receive a plurality of source domain objects and a plurality of destination domain objects from a user; store the plurality of source domain objects and the plurality of destination domain objects into a repository; analyze the plurality of destination domain objects to extract predefined annotations; parse the predefined annotations to extract mapping details and conditional details; traverse a metadata graph generated based on the predefined annotations to identify a matching path in a source domain that correlates with a class path present in the metadata graph, and evaluate at least one condition associated with the matching path using at least one source attribute value; and map the at least one source attribute value to at least one destination attribute value, upon satisfying the at least one condition.

In accordance with an exemplary embodiment, the executable code when executed may further cause the processor to traverse the metadata graph to identify an alternative matching path that correlates with the class path for mapping the at least one source attribute value to the at least one destination attribute value, upon failure to meet the at least one condition.

In accordance with an exemplary embodiment, the predefined annotations may include the at least one destination attribute value.

In accordance with an exemplary embodiment, the at least one source attribute value may be retrieved from the plurality of source domain objects.

In accordance with an exemplary embodiment, the executable code when executed may further cause the processor to determine an eligibility of the at least one destination attribute value represented through the matching path.

In accordance with an exemplary embodiment, the metadata graph may have a binary tree data structure.

In accordance with an exemplary embodiment, the executable code when executed may further cause the processor to traverse the metadata graph recursively to enhance path identification.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system to provide annotation-based domain mapping, in accordance with an exemplary embodiment of the present disclosure.

FIG. 2 illustrates an exemplary diagram of a network environment to provide annotation-based domain mapping, in accordance with an exemplary embodiment of the present disclosure.

FIG. 3 illustrates an exemplary system to provide annotation-based domain mapping, in accordance with an exemplary embodiment of the present disclosure.

FIG. 4 illustrates an exemplary method flow diagram to provide annotation-based domain mapping, in accordance with an exemplary embodiment of the present disclosure.

FIG. 5 illustrates a process flow diagram to demonstrate annotation-based domain mapping, in accordance with an exemplary embodiment of the present disclosure.

FIG. 6 illustrates a sequence flow diagram to demonstrate annotation-based domain mapping, in accordance with an exemplary embodiment of the present disclosure.

FIG. 7 illustrates a process flow diagram to show an implementation of an application-based domain mapping, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system to provide an annotation-based domain mapping. More particularly, existing domain mapping utilities often require developers to write custom code for each mapping and lack conditional mapping capabilities restricting their effectiveness in complex mapping requirements. The present disclosure provides a utility for mapping data entities between domains based on annotations and conditional logic, eliminating the need for manual code development, and providing enhanced flexibility compared to existing domain mapping solutions. In the present disclosure, at first, the system receives a plurality of source domain objects and a plurality of destination domain objects from a user. Further, the system stores the plurality of source domain objects and the plurality of destination domain objects. Further, the system analyzes the plurality of destination domain objects to extract predefined annotations. Further, the system parses the predefined annotations to extract mapping details and conditional details. Further, the system traverses a metadata graph generated based on the predefined annotations to identify a matching path in a source domain that correlates with a class path present in the metadata graph, and evaluates at least one condition associated with the matching path using at least one source attribute value. Thereafter the system maps the at least one source attribute value to at least one destination attribute value, upon satisfying the at least one condition. In this way, the system provides the utility for mapping data entities between domains based on annotations and conditional logic.

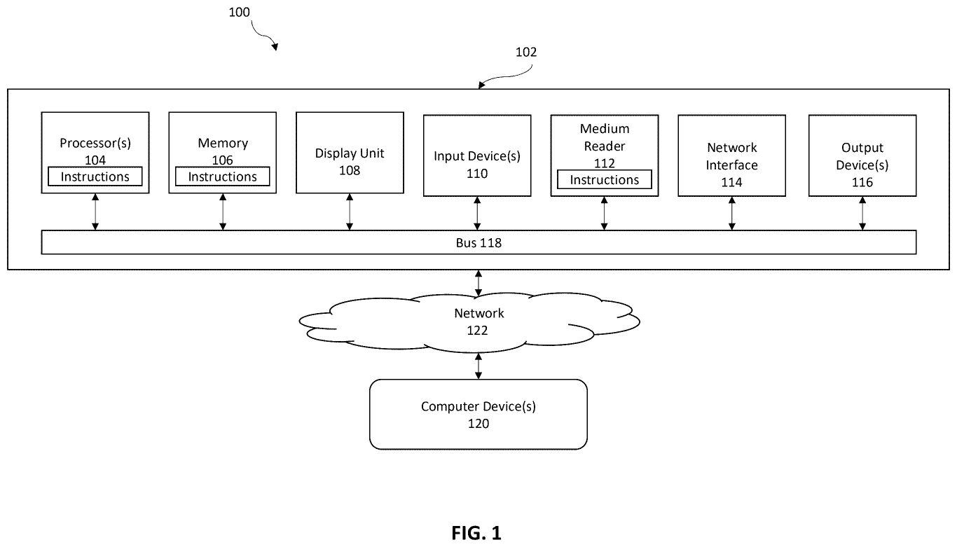

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specification.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to provide annotation-based domain mapping.

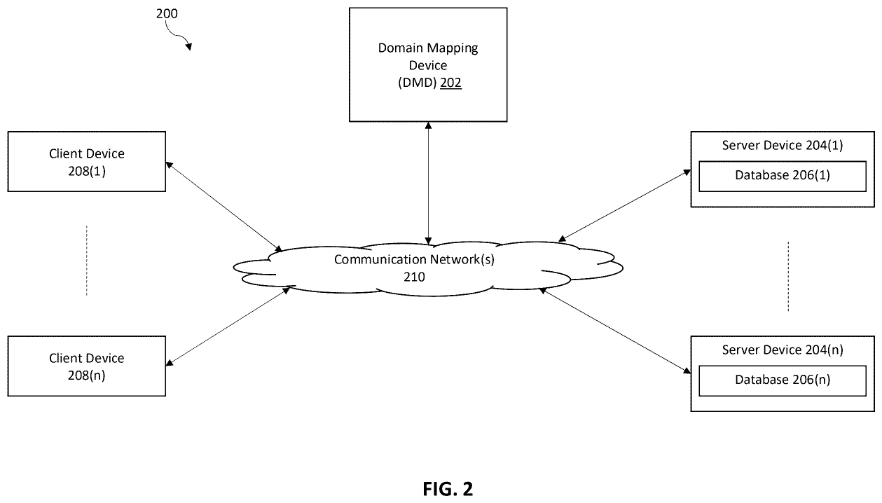

Referring to FIG. 2, a schematic of an exemplary network environment 200 to provide annotation-based domain mapping is illustrated. In an exemplary embodiment, the method is executable on any networked computer platform, such as, for example, a personal computer (PC).

The method to provide annotation-based domain mapping may be executed by a domain mapping device (DMD) 202. The DMD 202 may be the same or similar to the computer system 102 as described with respect to FIG. 1. The DMD 202 may store one or more applications that may include executable instructions that, when executed by the DMD 202, cause the DMD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the DMD 202 itself, may be located in the virtual server(s) running in a cloud-based computing environment rather than being tied to one or more specific physical network computing devices. Also, the application(s) may be running in one or more virtual machines (VMs) executing on the DMD 202. Additionally, in one or more embodiments of this technology, virtual machine(s) running on the DMD 202 may be managed or supervised by a hypervisor.

In the network environment 200 of FIG. 2, the DMD 202 is coupled to a plurality of server devices 204(1)-204(n) that hosts a plurality of databases 206(1)-206(n), and also to a plurality of client devices 208(1)-208(n) via communication network(s) 210. A communication interface of the DMD 202, such as the network interface 114 of the computer system 102 of FIG. 1, operatively couples and communicates between the DMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and DMDs that efficiently implement the method to provide an annotation-based domain mapping.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The DMD 202 may be a standalone device or integrated with one or more other devices or apparatuses, such as one or more of the server devices 204(1)-204(n), for example. In one particular example, the DMD 202 may include or be hosted by one of the server devices 204(1)-204(n), and other arrangements are also possible. Moreover, one or more of the devices of the DMD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the DMD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to predefined annotations, mapping details, and conditional details related to a plurality of domain objects.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DMD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the DMD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the DMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DMD 202, the server devices 204(1)-204(n), or the client devices 208(1)-208(n), for example, may be configured to operate as virtual instances on the same physical machine. In other words, one or more of the DMD 202, the server devices 204(1)-204(n), or the client devices 208(1)-208(n) may operate on the same physical device rather than as separate devices communicating through communication network(s) 210. Additionally, there may be more or fewer DMDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

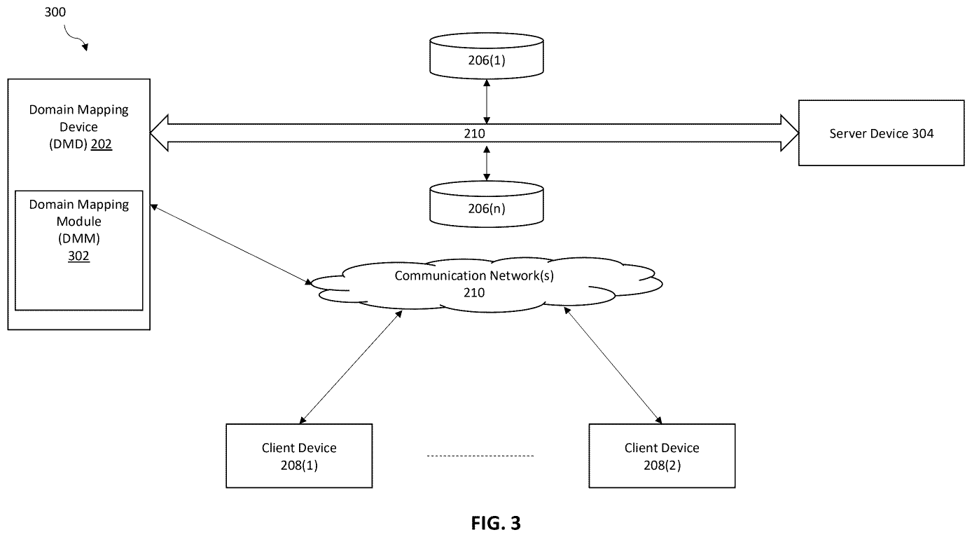

FIG. 3 illustrates a system diagram for providing annotation-based domain mapping, in accordance with an exemplary embodiment.

As illustrated in FIG. 3, the system 300 may include a domain mapping device (DMD) 202 within which a domain mapping module (DMM) 302 is embedded, a server 304, a database(s) 206(1). . .206(n), a plurality of client devices 208(1) ... 208(2), and a communication network(s) 210.

According to exemplary embodiments, the system 300 may comprise the domain mapping device (DMD) 202 including the DMM 302 may be connected to the server 304 and the database(s) 206(1) . . . 206(n) via the communication network(s) 210, but the disclosure is not limited thereto. The DMD 202 may also be connected to the plurality of client devices 208(1) . . . 208(2) via the communication network(s) 210, but the disclosure is not limited thereto. The database(s) 206(1). . .206(n) may include a rule database.

In an embodiment, the DMD 202 as described and shown in FIG. 3 includes the DMM 302, although it may include other rules, policies, modules, databases, or applications, for example. As will be described below, the DMM 302 is configured to carry out a method for providing annotation-based domain mapping.

An exemplary system 300 for providing annotation-based domain mapping by utilizing the network environment of FIG. 2 is shown as being executed in FIG. 3. Specifically, a first client device 208(1) and a second client device 208(2) are illustrated as being in communication with DMD 202. In this regard, the first client device 208(1) and the second client device 208(2) may be “clients” of the DMD 202 and are described herein as such. Nevertheless, it is to be known and understood that the first client device 208(1) and/or the second client device 208(2) need not necessarily be “clients” of the DMD 202, or any entity described in association therewith herein. Any additional or alternative relationship may exist between either or both of the first client device 208(1) and the second client device 208(2) and the DMD 202, or no relationship may exist.

Further, the DMD 202 is illustrated as being able to access one or more database(s) 206(1) . . . 206(n). The DMM 302 may be configured to access these repositories/databases to provide annotation-based domain mapping. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the DMD 202 via broadband or cellular communication. These embodiments are merely exemplary and are not limiting or exhaustive.

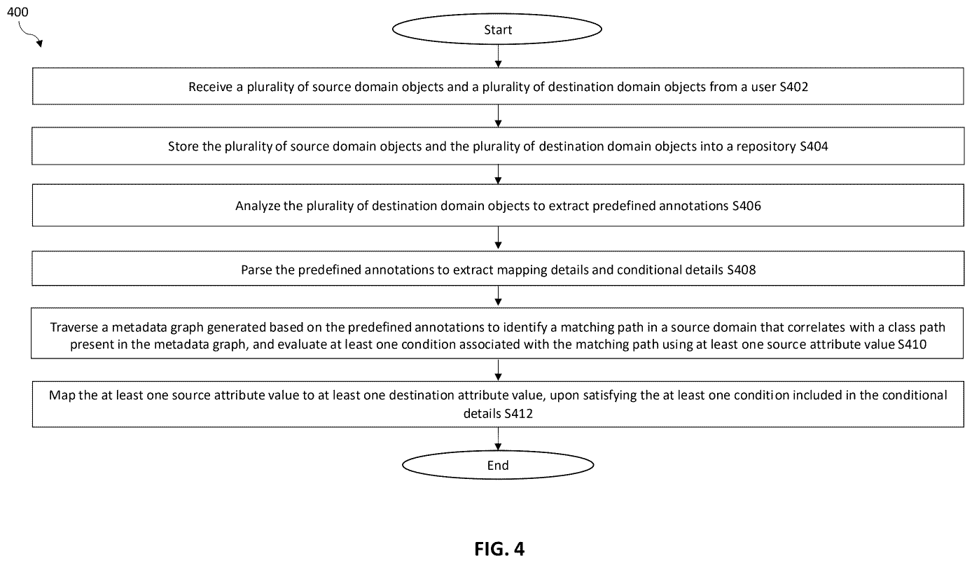

Referring to FIG. 4, an exemplary method 400 is shown for providing an annotation-based domain mapping, in accordance with an exemplary embodiment. In particular, the exemplary method 400 is shown for providing the annotation-based domain mapping.

As shown in FIG. 4, method 400 begins following a need to provide a utility for mapping data entities between domains and transferring data from one service to another service. The method 400 is implemented by at least one processor 104.

At step S402, the method 400 includes receiving, by the at least one processor 104, a plurality of source domain objects and a plurality of destination domain objects from a user.

The term “source domain objects” herein may correspond to data objects, entities, and/or records originating from a specific source system or domain in its original form, structure, and context within the source environment.

The term “destination domain objects” herein may correspond to the data objects or entities in a target or destination system or domain. The destination domain objects are typically the result of the mapping or processing applied to the source domain objects to fit into the structure or requirements of the destination environment.

The term “source environment” herein may correspond to the system, platform, and/or ecosystem from which data or information is originating. The term “destination environment” herein may correspond to the system, platform, and/or ecosystem where data is being transferred, loaded, or integrated from the source environment.

For example, a user may provide the plurality of source domain objects and the plurality of destination domain objects via an application (e.g., Java application).

In an exemplary implementation, the method includes receiving, by the at least one processor 104, the plurality of source domain objects and the plurality of destination domain objects from at least one computing device operated by the user. The computing device may be selected from but is not limited to, a personal computer, a virtual desktop computer, a tablet computer, a mobile device, a palmtop computer, a laptop computer, a desktop computer, a communications device, a wireless smartphone, and a wearable device.

It would be appreciated by the person skilled in the art that the aim here is to create a system that provides a utility for mapping data entities between domains based on annotations and conditional logic, eliminating the need for manual code development, and providing enhanced flexibility as compared to existing domain mapping solutions.

At step S404, the method includes storing, by the at least one processor 104, the plurality of source domain objects and the plurality of destination domain objects into a repository (e.g., a database or a memory module).

For example, the at least one processor 104 may trigger the loading of the plurality of source domain objects and the plurality of destination domain objects into the repository (e.g., the memory module or database) for further processing.

At step S406, the method includes analyzing, by the at least one processor 104, the plurality of destination domain objects to extract predefined annotations. The predefined annotations include at least one destination attribute value.

The term “annotations” herein may correspond to metadata elements in the form of tags or markers that may be added to code elements, such as classes, fields, or methods, to convey additional information or instructions to the mapping utility or framework.

For example, the predefined annotations may be provided by the user by using a user interface of an application (e.g., Java application) to ensure taxonomy-based domain mapping.

At step S408, the method includes parsing, by the at least one processor 104, the predefined annotations to extract mapping details and conditional details. The mapping details may include mapping logic and a plurality of operators such as AND, OR, string, double, long, dot, and star. The mapping logic includes mapping rules defined through the predefined annotations to ensure consistent mapping outcomes. The mapping details are parsed from the predefined annotations (e.g., user-defined annotations specify mapping logic). For example, one such mapping detail may be to map a source attribute value to a destination attribute value. The conditional details may include but are not limited to a plurality of predefined conditions such as equals any, not equal any, not null, null, ignore, ignore case, null check, and ignore null.

At step S410, the method includes traversing, by the at least one processor 104, a metadata graph (hereinafter also referred to as a binary tree structure) generated based on the predefined annotations to identify a matching path in a source domain that correlates with a class path present in the metadata graph, and evaluating at least one condition associated with the matching path using at least one source attribute value.

The metadata graph may have an internal binary tree data structure that is constructed by the at least one processor 104. The at least one source attribute value may be retrieved from the plurality of source domain objects. In an exemplary implementation, the at least one source attribute value is received from an upstream application (e.g., Java application).

The term “metadata graph” herein may correspond to a graphical representation or visualization of the metadata associated with each node of the binary tree.

The term “binary tree structure” herein may correspond to the hierarchical representation of data domains or entities and their mapping relationships, facilitating the efficient mapping of data between different domains within a mapping utility or framework.

The traversing of the metadata graph may be performed recursively to enhance path identification. The method may further include determining, by the at least one processor 104, an eligibility of the at least one destination attribute value represented through the matching path. In an exemplary implementation, the eligibility of the at least one destination attribute value is determined based on a matching condition and the matching path.

At step S412, the method includes mapping, by the at least one processor 104, the at least one source attribute value to the at least one destination attribute value, upon satisfying the at least one condition included in the conditional details.

The term “attribute” herein may correspond to a characteristic or a property of an object or entity that describes its qualities or features.

The term “class path” herein may correspond to the set of directories or Java archive (JAR) files containing Java classes and resources that are used by a Java virtual machine (JVM) to locate and load classes at runtime.

In an exemplary implementation, the method includes receiving, by the at least one processor 104, the binary tree data structure to perform an analysis of the plurality of source domain objects by traversing through the binary tree data structure and then identifying each attribute in a destination domain eligible for mapping. Each attribute in the destination domain eligible for the mapping may be parsed within the source domain.

In an exemplary implementation, the method further includes applying, by the at least one processor 104, the at least one source attribute value to the at least one destination attribute value to map a destination domain object out of the plurality of the destination domain objects, upon satisfying the at least one condition. In an embodiment, the at least one condition is included in the conditional details.

The at least one source attribute value may be retrieved from the plurality of source domain objects by the at least one processor 104. In an exemplary implementation, the at least one source attribute value is retrieved from the plurality of source domain objects based on the at least one condition defined in the destination domain.

For example, the at least one processor 104 may utilize the class path to navigate a source domain based on a current path in the binary tree data structure to identify a matching path. The matching path may be identified based on a correlation with the class path. The at least one processor 104 may further evaluate the at least one condition associated with the matching path in the metadata graph or the binary tree data structure using the retrieved source attribute value.

For example, in the event of meeting the at least one condition, the at least one processor 104 may map the corresponding source attribute value to the at least one destination attribute value represented by the matching path. For example, in case the at least one condition and a path defined at the destination domain are matching with the class path and a value for condition evaluation, then the mapping may be performed successfully (or mapping is considered as successful mapping). Alternatively, upon the missed condition (e.g., upon failure to meet the at least one condition), the at least one processor 104 may skip the current mapping and move to a subsequent mapping.

The method may further include traversing, by the at least one processor 104, the metadata graph to identify an alternative matching class path for mapping the at least one source attribute value to the at least one destination attribute value, upon failure to meet the at least one condition.

For example, once mappings for all the source attributes are completed, the at least one processor 104 may return the transformed or mapped destination domain object(s) to the application (e.g., Java application).

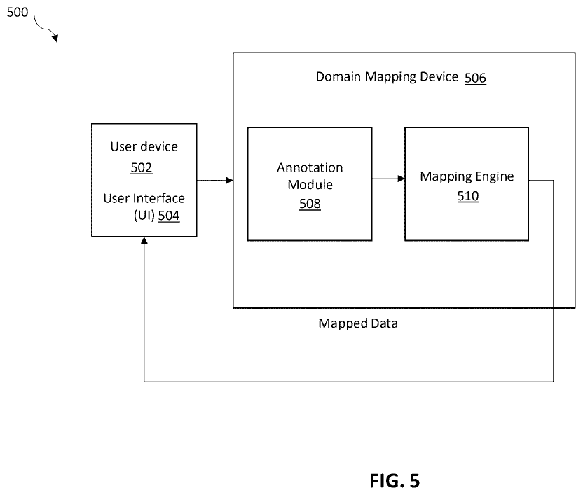

FIG. 5 illustrates a process flow diagram that represents a method to provide annotation-based domain mapping, in accordance with an exemplary embodiment. As illustrated in FIG. 5, the process flow 500 begins with receiving a plurality of source domain objects and a plurality of destination domain objects from a user (e.g., developers) via a user device 502. The user device 502 may be employed with a user platform or an application (e.g., Java application) and by using a user interface (UI) 504 of the user platform, the user may call an annotation module 508 to provide the plurality of source domain objects and the plurality of destination domain objects.

Further, the plurality of source domain objects and the plurality of destination objects are received by the annotation module 508. The annotation module 508 may be installed in a domain mapping device 506. The annotation module 508 enables users to attach annotations (e.g., predefined annotations) to the plurality of source domain objects and the plurality of destination domain objects within their corresponding domain (for example, a source domain and a destination domain). The predefined annotations provide metadata for mapping rules. The predefined annotations are fetched from the destination domain objects by the annotation module 508. The predefined annotations may include conditional logic expressions for dynamic mapping decisions.

Further, a mapping engine 510 is configured to interpret the predefined annotations and extract mapping details and condition details to automate the mapping between domains (e.g., the source domain and the destination domain). The mapping engine 510 is configured to execute a mapping logic without requiring manual code implementations from the user (e.g., developer). Further, the mapping engine 510 applies at least one source attribute value to at least one destination attribute value to map a destination domain object out of the plurality of the destination domain objects, upon satisfying at least one condition mentioned in the conditional details. The at least one source attribute value is retrieved from the plurality of source domain objects. Once all the mappings are completed, the mapping engine 510 returns mapped data such as the at least one destination domain object to the user platform (e.g., Java application) on the user device 502.

It would be appreciated by the person skilled in the art that the disclosed method offers a full-circle, adaptable, and intelligent solution for implementing a method to provide annotation-based domain mapping.

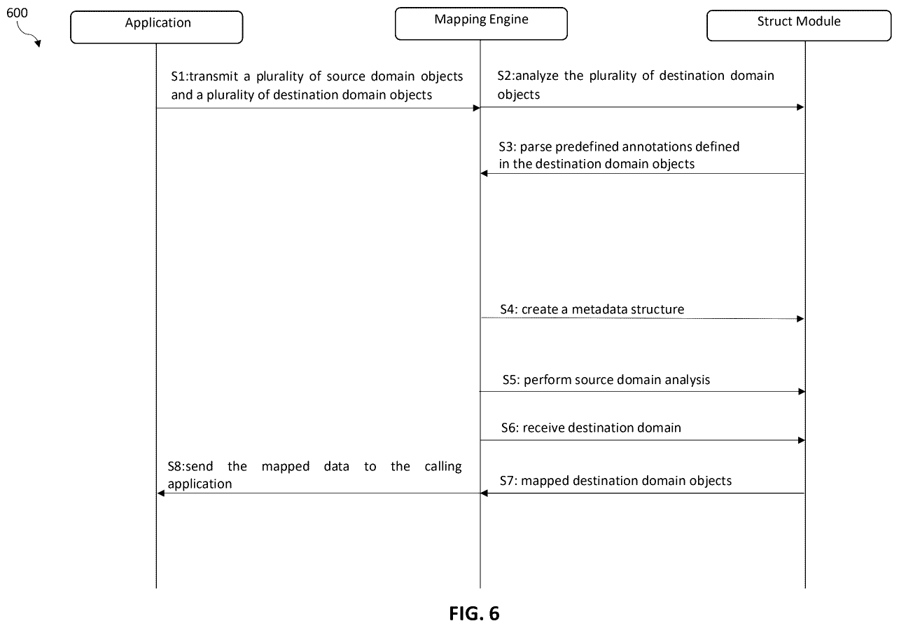

FIG. 6 illustrates an exemplary sequence flow diagram 600 that represents a method to provide annotation-based domain mapping, in accordance with an exemplary embodiment. As illustrated in FIG. 6, the process flow 600 begins with receiving a plurality of source domain objects and a plurality of destination domain objects from a user (e.g., developer) via an application (e.g., a Java application) installed in a user device. At step S1, the application calls a mapping engine (hereinafter also referred to as “mapping utility”) and transmits the plurality of source domain objects and the plurality of destination domain objects to the mapping utility. The mapping utility receives the plurality of source domain objects and the plurality of destination domain objects, and triggers the loading of the plurality of source domain objects and the plurality of destination domain objects in a memory module or database for efficient access and further processing.

The mapping utility further transmits the plurality of destination domain objects to a struct module. At step S2, the struct module analyzes predefined annotations fetched from the plurality of destination domain objects. At step S3, the struct module is configured to parse the predefined annotations defined in a destination domain and transmit back the predefined annotations to the mapping utility. At step S4, the struct module receives a metadata structure that is created based on the predefined annotations, from the mapping utility. At step S5, the struct module receives source values from a source domain (or via an upstream application) by performing source domain analysis via the mapping utility. At step S6, the struct module receives the destination domain from the mapping utility. At steps S7 and S8, the struct module transmits mapped destination domain objects to the mapping utility and further sends the mapped destination domain objects to the application.

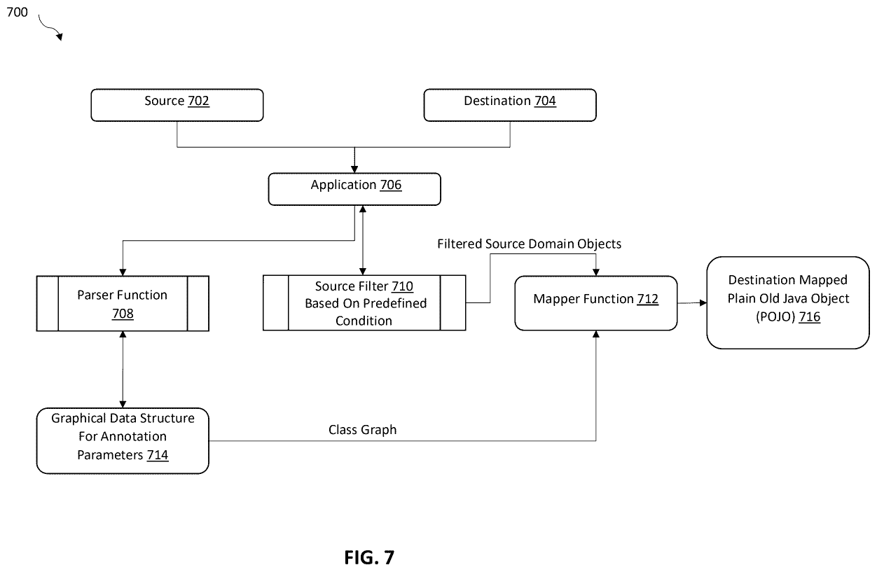

FIG. 7 illustrates a process flow diagram that demonstrates or represents the implementation of an application-based domain mapping, in accordance with an exemplary embodiment. As illustrated in FIG. 7, the process flow 700 begins with receiving a plurality of source domain objects from a source 702 and a plurality of destination domain objects from a destination 704 by an application 706 (e.g., a user platform or Java application) installed in a user device operated by a user (e.g., developer).

The application 706 transmits the plurality of source domain objects to a source filter 710 that filters the source domain objects based on a predefined condition. Further, the filtered source domain objects are transmitted to a mapper function 712.

Further, the application 706 transmits the plurality of source domain objects and the plurality of destination domain objects to a parser function 708 which parses all plain old java objects (POJO) annotated with a mapper domain and creates a metadata graph (e.g., a binary tree data structure) for all annotated attributes present in the plurality of destination domain objects. Further, a graphical data structure 714 for annotation parameters is created by the parser function 708. Further, a class graph is transmitted to the mapper function 712 from the graphical data structure 714. After receiving the filtered source domain objects, the mapper function 712 starts mapping labeled attributes with the values and returns the mapped destination objects POJO 716. For example, the mapper function 712 applies at least one source attribute value to at least one destination attribute value to map a destination domain object out of the plurality of destination domain objects, upon satisfying at least one condition.

The present disclosure provides numerous advantages as given below. The present disclosure provides a utility for mapping data entities between domains based on annotations and conditional logic, eliminating the need for manual code development, and providing enhanced flexibility compared to existing solutions. The present disclosure eliminates the need for manual code writing for each domain mapping, reducing development time and effort. The present disclosure further empowers developers to define mapping rules and conditions through annotations, enabling adaptability to diverse mapping scenarios without extensive code changes. The present disclosure reduces errors stemming from manual code development and ensures consistent mapping outcomes through the automated execution of rules. The present disclosure enables complex mapping decisions based on specific criteria, enhancing the utility's applicability to a broader range of use cases. The present disclosure provides a user-friendly interface for defining annotations, mapping rules, and conditions, and fostering efficient and intuitive development workflows. The present disclosure minimizes the need for ongoing code revisions as mapping requirements evolve, resulting in lower maintenance overhead. The present disclosure promotes the utility of domain mapping logic across multiple projects, fostering code efficiency and knowledge sharing. In addition, the present disclosure aims to address the following common pain points and challenges faced by developers in domain mapping tasks such as simplifying the testing and reducing the code revisions as mapping needs change, leading to lower maintenance costs.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present disclosure describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present disclosure may encompass software, firmware, and hardware implementations, or combinations thereof. Nothing in the present disclosure should be interpreted as being implemented or implementable solely with software and not hardware.

According to an aspect of the present disclosure, a non-transitory computer-readable storage medium storing instructions to provide annotation-based domain mapping is disclosed. The instructions include executable code which, when executed by a processor 104, may cause the processor 104 to receive, via a communication interface, a plurality of source domain objects and a plurality of destination domain objects from a user; store the plurality of source domain objects and the plurality of destination domain objects into a repository; analyze the plurality of destination domain objects to extract predefined annotations; parse the predefined annotations to extract mapping details and conditional details; traverse a metadata graph generated based on the predefined annotations to identify a matching path in a source domain that correlates with a class path present in the metadata graph, and evaluate at least one condition associated with the matching path using at least one source attribute value; and map the at least one source attribute value to at least one destination attribute value, upon satisfying the at least one condition.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method to provide an annotation-based domain mapping, the method being implemented by at least one processor, the method comprising:
receiving, by the at least one processor, a plurality of source domain objects and a plurality of destination domain objects from a user;
storing, by the at least one processor, the plurality of source domain objects and the plurality of destination domain objects into a repository;
analyzing, by the at least one processor, the plurality of destination domain objects to extract predefined annotations;
parsing, by the at least one processor, the predefined annotations to extract mapping details and conditional details;
traversing, by the at least one processor, a metadata graph generated based on the predefined annotations to identify a matching path in a source domain that correlates with a class path present in the metadata graph, and evaluating at least one condition associated with the matching path using at least one source attribute value; and
mapping, by the at least one processor, the at least one source attribute value to at least one destination attribute value, upon satisfying the at least one condition.

2. The method as claimed in claim 1, further comprising:
traversing, by the at least one processor, the metadata graph to identify an alternative matching path that correlates with the class path for mapping the at least one source attribute value to the at least one destination attribute value, upon failure to meet the at least one condition.

3. The method as claimed in claim 1, wherein the predefined annotations comprise the at least one destination attribute value.

4. The method as claimed in claim 1, wherein the at least one source attribute value is retrieved from the plurality of source domain objects.

5. The method as claimed in claim 1, further comprising:
determining, by the at least one processor, an eligibility of the at least one destination attribute value represented through the matching path.

6. The method as claimed in claim 1, wherein the metadata graph has a binary tree data structure.

7. The method as claimed in claim 2, wherein the traversing of the metadata graph is performed recursively to enhance path identification.

8. A computing device configured to provide an annotation-based domain mapping, the computing device comprising:
a processor;
a memory; and
a communication interface coupled to each of the processor and the memory,
wherein the processor is configured to:
receive a plurality of source domain objects and a plurality of destination domain objects from a user;
store the plurality of source domain objects and the plurality of destination domain objects into a repository;
analyze the plurality of destination domain objects to extract predefined annotations;
parse the predefined annotations to extract mapping details and conditional details;
traverse a metadata graph generated based on the predefined annotations to identify a matching path in a source domain that correlates with a class path present in the metadata graph, and evaluate at least one condition associated with the matching path using at least one source attribute value; and
map the at least one source attribute value to at least one destination attribute value, upon satisfying the at least one condition.

9. The computing device as claimed in claim 8, wherein the processor is further configured to traverse the metadata graph to identify an alternative matching path that correlates with the class path for mapping the at least one source attribute value to the at least one destination attribute value, upon failure to meet the at least one condition.

10. The computing device as claimed in claim 8, wherein the predefined annotations comprise the at least one destination attribute value.

11. The computing device as claimed in claim 8, wherein the at least one source attribute value is retrieved from the plurality of source domain objects.

12. The computing device as claimed in claim 8, wherein the processor is further configured to determine an eligibility of the at least one destination attribute value represented through the matching path.

13. The computing device as claimed in claim 8, wherein the metadata graph has a binary tree data structure.

14. The computing device as claimed in claim 9, wherein the processor is configured to traverse the metadata graph recursively to enhance path identification.

15. A non-transitory computer readable storage medium storing instructions to provide an annotation-based domain mapping, the storage medium comprising executable code which, when executed by a processor, causes the processor to:
receive a plurality of source domain objects and a plurality of destination domain objects from a user;
store the plurality of source domain objects and the plurality of destination domain objects into a repository;
analyze the plurality of destination domain objects to extract predefined annotations;
parse the predefined annotations to extract mapping details and conditional details;
traverse a metadata graph generated based on the predefined annotations to identify a matching path in a source domain that correlates with a class path present in the metadata graph, and evaluate at least one condition associated with the matching path using at least one source attribute value; and
map the at least one source attribute value to at least one destination attribute value, upon satisfying the at least one condition.

16. The storage medium as claimed in claim 15, wherein when executed by the processor, the executable code further causes the processor to traverse the metadata graph to identify an alternative matching path that correlates with the class path for mapping the at least one source attribute value to the at least one destination attribute value, upon failure to meet the at least one condition.

17. The storage medium as claimed in claim 15, wherein the predefined annotations comprise the at least one destination attribute value.

18. The storage medium as claimed in claim 15, wherein the at least one source attribute value is retrieved from the plurality of source domain objects.

19. The storage medium as claimed in claim 15, wherein when executed by the processor, the executable code further causes the processor to determine an eligibility of the at least one destination attribute value represented through the matching path.

20. The storage medium as claimed in claim 16, wherein when executed by the processor, the executable code further causes the processor to traverse the metadata graph recursively to enhance path identification.
